(19) United States
(12) Patent Application Publication
(10) Pub. No.: US 2008/0232558 A1
(43) Pub. Date: Sep. 25, 2008

(54) Dynamic Voice File Creation and Organization for Leaving Messages in the Event of a Catastrophe

(76) Inventor: Robert Howe Pinckney, Houston, TX (US)

Correspondence Address: OSHA LIANG L.L.P., 1221 MCKINNEY STREET, SUITE 2800, HOUSTON, TX, 77010, US

(21) Appl. No.: 12/066,379

(22) PCT Filed: Sep. 8, 2006
(86) PCT No.: PCT/US06/34978

§ 371 Date: Mar. 10, 2008

Related U.S. Application Data
(60) Provisional application No. 60/715,776, filed on Sep. 9, 2005.

(51) Int. Cl. H04M 1/64; H04L 12/58

(52) U.S. Cl. 379/88.17; 455/412.1

(57) ABSTRACT

A system for message storage and retrieval that includes a first data repository, and a first communication manager configured to obtain an identifier and a message from a first user, create a first message mailbox associated with the identifier in the first data repository after receiving the message, store the message in the first data repository, relate the message with the first message mailbox associated with the identifier, and retrieve the message from the first message mailbox associated with the identifier provided by a second user.

### CROSS-REFERENCE TO RELATED APPLICATIONS

This application claims benefit under 37 CFR § 1.78 of U.S. Provisional Application Ser. No. 60/715,776 filed on Sep. 9, 2005, entitled “Dynamic voice file creation and organization for leaving messages in the event of a catastrophe,” with the same inventor, Robert Pinckney.

### BACKGROUND

Communication (i.e., phone calls, conversations, e-mails, etc.) is a way for one person to determine the status of another person. For example, people may communicate to determine the location of a person, the person's well-being (mental and physical), etc. When it is not possible to have a direct, in-person conversation to communicate relevant information, substitute means of communication may need to be employed.

Historically, substitute means of communication have included written communication in form of letters, notes, postal mail, etc. More recently, substitute means of communication have rapidly evolved to include telephones, voicemail boxes, internet communication, electronic mail (e-mail), etc.

During an occurrence of a natural disaster, an unexpected separation at a public place, or any other situation when time and circumstances may not permit use of the more traditional communication means, the use of substitute channels or means of communication is extremely valuable. Specifically, during times of separation, acquaintances (e.g., family, friends, co-workers, etc.) may want to communicate to identify status and well-being of a person, obtain information, etc.

One channel for communication which may be employed during such situations is exchanging hand-written or electronic messages using a message board or a pole at a public place (e.g., university, public library, town square, etc.). For example, acquaintances may write a message on a sheet of paper to add to the board or sift through the messages on the board to communicate. Another channel for communication is the use of a web-based interface to propagate and retrieve data. For example, acquaintances can access a website through a web-browser over a network and conduct a search for messages by specifying search criteria like date of birth, last known town, etc. of the person being searched, sort through irrelevant messages, and if matching messages are found, making contact through the contact information provided in the message.

An additional communication channel that may be used to communicate with a missing or otherwise interested person is by attempting to contact the person by phone. If the person is not immediately reachable, a voice message may be recorded and deposited into a pre-existing voice mailbox.

### SUMMARY

In general, in one aspect, the invention relates to a system for message storage and retrieval that includes a first data repository, and a first communication manager configured to obtain an identifier and a message from a first user, create a first message mailbox associated with the identifier in the first data repository after receiving the message, store the message in the first data repository, relate the message with the first message mailbox associated with the identifier, and retrieve the message from the first message mailbox associated with the identifier provided by a second user.

In general, in one aspect, the invention relates to a method for message storage and retrieval that includes obtaining an identifier and a message from a first user, creating a first message mailbox associated with the identifier in a messaging infrastructure after receiving the message, storing the message in the messaging infrastructure, relating the message with the first message mailbox associated with the identifier, retrieving the message from the first message mailbox associated with the identifier provided by a second user.

In general, in one aspect, the invention relates to a computer readable medium that includes instructions embodied thereon for causing a computer system to obtain an identifier and a message from a first user, create a first message mailbox associated with the identifier in a messaging infrastructure after receiving the message, store the message in the messaging infrastructure, relate the message with the first message mailbox associated with the identifier, retrieve the message from the first message mailbox associated with the identifier provided by a second user.

Other aspects of the invention will be apparent from the following description and the appended claims.

### BRIEF DESCRIPTION OF DRAWINGS

FIG. 1 shows a schematic diagram of a system in accordance with one or more embodiments of the invention.

FIG. 2 shows a flowchart of a method for user communication in accordance with one or more embodiments of the invention.

FIG. 3 shows a flowchart of a method for message storage and retrieval in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention are directed to a method and system for providing a means for users (e.g., acquaintances, friends, family, co-workers, etc.) to communicate. Specifically, embodiments of the invention, allow dynamic creation of message mailboxes after the message is received. More specifically, if users are each in different locations, unknown to each other, and are not able to communicate through standard communication channels, embodiments of the invention allow a user to leave a message in a message mailbox which is accessible by others.

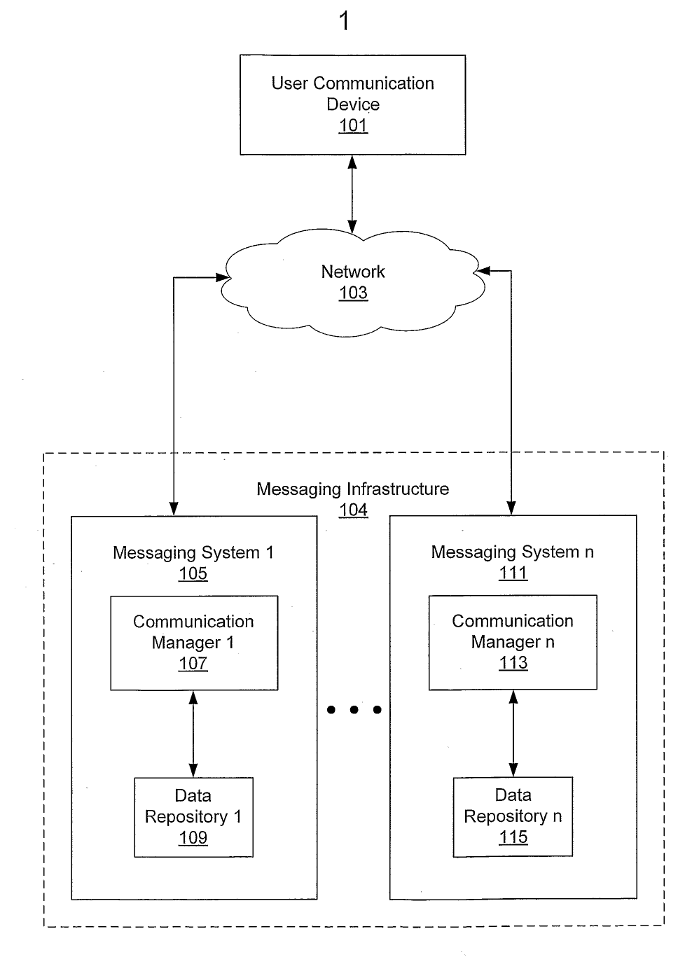

FIG. 1 shows a schematic diagram of a system in accordance with one or more embodiments of the invention. As shown in FIG. 1, the system includes a user communication device (101), a network (103), and a messaging infrastructure (104). Each of these components is described below.

The user communication device (101) corresponds to any type of a communication device used for communication. For example, the user communication device (101) may correspond to a landline telephone (e.g., a pay phone, a personal telephone, etc.), a mobile cellular telephone, a satellite telephone, a computer system (e.g., a laptop computer, a desktop computer, a Personal Digital Assistant (PDA), etc.) or any other type of communication device. Further, the user communication device (101) may or may not be owned by the user. For example, the user communication device (101) may be a landline telephone in a disaster recovery shelter or website on a computer system in a coffee shop.

In one or more embodiments of the invention, the user communication device (101) is coupled to a network (103) in accordance with one or more embodiments of the invention. The network (103) corresponds to a public and/or private communication medium that includes functionality to transmit data between and/or within different components of the system. For example, the network may correspond to a Public Switched Telephone Network (PSTN), an Internet-based Voice over Internet Protocol (VOIP) network, a circuit-switched telephone network, a Wide Area Network (WAN) (e.g., the Internet), a wireless network, a satellite network, or other similar networks.

A messaging infrastructure (104) is coupled to the network (103) in accordance with one or more embodiments of the invention. A messaging infrastructure (104) corresponds to an interconnection of one or more messaging systems (e.g., messaging system 1 (105), messaging system n (111)). A messaging system (e.g., messaging system 1 (105), messaging system n (111)) corresponds to a logical and/or physical entity that includes functionality to store and retrieve messages. When multiple messaging systems exist, the messaging systems may be geographically dispersed (e.g., different buildings, cities, states, countries, continents, etc.) in accordance with one or more embodiments of the invention. Specifically, each messaging system (e.g., messaging system 1 (105), messaging system n (111)) may cater to a specific geographic location. Further, a specific geographic location may include multiple messaging systems. In addition, a single messaging system may cater to multiple geographic locations based upon availability and need.

In one or more embodiments of the invention, the messaging system (e.g., messaging system 1 (105), messaging system n (111)) may be a mobile messaging system that is coupled to the messaging infrastructure (104) via a satellite link or any other similar mobile communication link. In one or more embodiments of the invention, a mobile messaging system may be initialized within a relatively short amount of time. Further, the size of a mobile messaging system may correspond to a cabinet the size of a normal office desk. Accordingly, the mobile messaging system may be carried by truck, car, helicopter, plane, etc., and may even be powered by a portable generator.

A messaging system (e.g., messaging system 1 (105), messaging system n (111)) may be constantly available, newly activated and made available, etc. Specifically, a messaging system may be continually on or activated only in times of need.

Continuing with the discussion of FIG. 1, the messaging system (e.g., messaging system 1 (105), messaging system n (111)) includes a data repository (e.g., data repository 1 (109), data repository n (115)) and a communication manager (e.g., communication manager 1 (107), communication manager n (113)).

The data repository (e.g., data repository 1 (109), data repository n (115)) corresponds to any type of data storage mechanism (e.g., a hierarchical database, object-oriented database, relational database, indexed database, a third party data storage and retrieval service provider, linked files, etc.) for messages within the messaging system (e.g., messaging system 1 (105), messaging system n (111)). The data repository (e.g., data repository 1 (109), data repository n (115)) may also store automated response messages (described below) used by the communication manager (e.g., communication manager 1 (107), communication manager n (113)).

Additionally, the data repository (e.g., data repository 1 (109), data repository n (115)) may include hardware and software components. For example, the data repository (e.g., data repository 1 (109), data repository n (115)) may correspond to one or more optical disk storage device (or any other type of physical storage device) which stores all the messages in the messaging system (e.g., messaging system 1 (105), messaging system n (111)). In another example, the data repository (e.g., data repository 1 (109), data repository n (115)) may correspond to a software component which interacts with a third party data storage service that stores messages for a specific messaging system.

Further, while FIG. 1 shows that each messaging system includes an individual data repository, in one or more embodiments of the invention, multiple messaging systems may update a single data repository. In particular, the single data repository may be shared across all or part of the messaging system in the messaging infrastructure.

Continuing with FIG. 1, the data repository (e.g., data repository 1 (109), data repository n (115)) includes functionality to store messages in message mailboxes (not shown). In one or more embodiments of the invention, a message mailbox corresponds to one or more logical connections between messages and one or more identifiers. For example, the message mailbox may correspond to a logical container, a logical relationship, etc.

An identifier may be used as a distinct identification mechanism for a user or a network of users (e.g., family, friends, coworkers, etc.). For example, the identifier may correspond to a unique alpha, numeric, or alphanumeric character set in accordance with one or more embodiments of the invention. For example, the identifier may correspond to a telephone number, a zip code, a street address, a driver's license number, a person's name, an animal's name, a license plate number, or a social security number. Further, if the identifier corresponds to a telephone number, then identifier may or may not correspond to a valid and/or operational telephone number. For example, the telephone number may be out of service due to a natural disaster; however the number is still a valid identifier for the purposes of this invention.

In one or more embodiments of the invention, multiple identifiers and multiple messages may be simultaneously associated with the same message mailbox. In particular, a message may be related at the same point in time to multiple identifiers. Conversely, an identifier may be simultaneously related to multiple messages. Specifically, a message mailbox may have multiple messages and a single message may be associated with multiple mailboxes. Thus, the relationships between messages and identifiers may correspond to a one-to-one, many-to-one, one-to-many, and/or a many-to-many relationship.

Continuing with FIG. 1, the communication manager (e.g., communication manager 1 (107), communication manager n (113)) includes functionality to interact with a user communication device (101) to store and receive messages. The communication manager (e.g., communication manager 1 (107), communication manager n (113)) may include components and functionality to communicate with a variety of types of network media. For example, the communication manager may include components and functionality to communicate via the Internet, a phone system, or any other similar network. Further, the communication manager may include a graphical user interface that includes a web interface, a telephone interface, etc.

Further, the communication manager (e.g., communication manager 1 (107), communication manager n (113)) may include an interactive voice response system (not shown) which is provided to the user to help navigate through the messaging system. In one or more embodiments of the invention, the interactive voice response system is a logical entity that enables the user to navigate through menus. Further, in one or more embodiments of the invention, the interactive voice response system includes one or more automated response messages.

In one or more embodiments of the invention, an automated response message is a message that provides instructions to the user. For example, the automated response message may include an auditory version of a menu with instructions of how to use the menu. The communication manager (e.g., communication manager 1 (107), communication manager n (113)) may also include functionality to provide an appropriate automated response message in response to any identifying string of numbers, letters, dual-tone multi-frequency (DTMF) signaling, or Internet Protocol (IP) control signals (i.e., SIPs) which are provided by the user through the user communication device (101).

Additionally, the communication manager (e.g., communication manager 1 (107), communication manager n (113)) may include functionality to understand the auditory input from the user in order to enable navigation of the user through functionalities provided by the messaging system (e.g., messaging system 1 (105), messaging system n (111)). Specifically, the communication manager (e.g., communication manager 1 (107), communication manager n (113)) may include speech recognition technology in order to understand user responses without necessitating the user to manually type input. For example, if a user is calling from a telephone, the user may speak a menu option rather than pressing a key that corresponds to the menu option on a touchtone phone.

Further, the communication manager (e.g., communication manager 1 (107), communication manager n (113)) may include functionality to communicate with the user in various languages based on the user's preferences. For example, the communication manager (e.g., communication manager 1 (107), communication manager n (113)) may be configured to allow the user to select English, Spanish, Japanese, Mandarin Chinese, French, German, Dutch, or any other language desired by the user. Additionally, messages may be stored in virtually any language.

In addition, in one or more embodiments of the invention, the communication manager (e.g., communication manager 1 (107), communication manager n (113)) may include the functionality of a telephone switch. As a telephone switch, the communication manager may include functionality to communicate using virtually any method or protocol (e.g., Primary Rate Interface (PRI), Integrated Services Digital Network (ISDN), Basic Rate Interface (BRI), Signaling System 7 (SS7), C7, Channel Associated Signaling (CAS), R1, R2, Session Initiation Protocol (SIP), H.323, Media Gateway Control Protocol (MGCP), Internet Protocol Device Control (IPDC), H.248, Media Gateway Controller (Megaco), Data Over Cable Service Interface Specification (DOCSIS), or any other method, protocol, or variant thereof.

By incorporating the functionality of a telephone switch, in one or more embodiments of the invention, the communication manager (e.g., communication manager 1 (107), communication manager n (113)) includes functionality to perform processing on a communication with a user based on user information, information about a receiver of the message, the Internet Protocol (IP) address of the user communication device, destination IP address, Telephone Number Mapping (ENUM) number, Automatic Number Identification (ANI), Dialed Number Identification Service (DNIS), or any other information included in data associated with the communication regardless of the type of communication.

For example, the communication manager (e.g., communication manager 1 (107), communication manager n (113)) may include functionality to perform enhanced service based upon automatically attained information. Enhanced service may include routing the communication to another messaging system (e.g., messaging system 1 (105), messaging system n (111)) or other component of the messaging infrastructure (104), or an external resource (e.g., Police department, fire department, Red Cross, or other similar groups or agency), changing the language, changing the menu options, forwarding the communication, storing the message locally, transferring the message from one location to another, playing a message or group of messages, or performing other services or actions on the call. Alternatively, the information to perform the actions may be obtained manually.

The communication may also include billing capabilities to bill and rate a communication based upon a pre-determined billing option, data associated with the communication, or any other parameter.

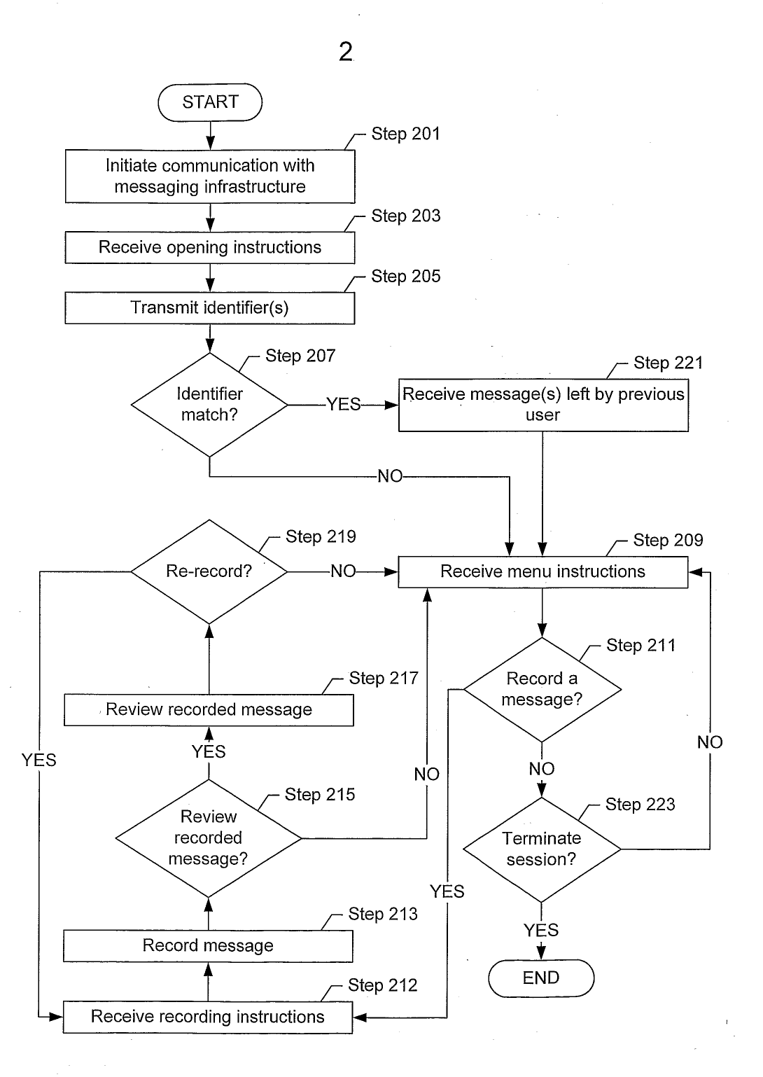

FIG. 2 shows a flowchart of a method for user communication in accordance with one or more embodiments of the invention. Initially, communication with the messaging infrastructure is initiated (Step 201). Initiation of communication may be performed by dialing a telephone number (e.g., a toll-free number, local phone number, long-distance phone number, etc.) through the user communication device to establish connectivity with the messaging infrastructure. The number may be easy-to-remember and available to the user through marketing and advertisement campaigns. For example, a toll-free number may be advertised through the local radio, television network, news media, and print media. In another example, during times of crisis, a toll-free number may be broadcasted to individuals affected by the crisis. Thus, the user may contact the messaging infrastructure by dialing the telephone number. Additionally, the telephone number may be linked to multiple telephone lines to enable multiple users to simultaneously access the messaging infrastructure in accordance with one or more embodiments of the invention.

Alternatively, initiation of communication by the user with the messaging infrastructure may also be done via a web-based interface (e.g., a website) over the Internet in accordance with one or more embodiments of the invention. Specifically, a person may communicate with the messaging infrastructure using input devices like a keyboard, a microphone, etc., and output devices like a computer screen, audible speakers, etc. Thus, the user is able to check for left messages by inputting an identifier and simply viewing messages or playing messages from a web-browser over connected speakers. In such embodiments, the Internet web-site (or similar web-interface access mechanisms) may be advertised and marketed through similar means as discussed above for accessing the messaging infrastructure through a telephone number.

Once communication with the messaging infrastructure has been established, the user receives a series of opening instructions (Step 203). For example, the opening instructions may include a series of automated responses to enable the user to navigate effectively through the functionality provided by the messaging infrastructure. Further, the series of automated response messages may include a welcome message to welcome the user, a language selection message to provide a list of languages from which the user may select a language, an identifier request message to request the user to provide an identifier, and any other type of message to enable the user to interact with the messaging infrastructure. Alternatively, the series of instructions may correspond to a different set of automated response messages as may be deemed appropriate.

In response to the received opening instructions, the user transmits an identifier (Step 205) in accordance with one or more embodiments of the invention. Transmitting an identifier may be performed, for example, by a user inputting the identifier into such devices as a dial pad on a touchtone phone, speaking the identifier into a microphone, or performing any other technique known in the art for identifier transmission.

Once the identifier is received, a determination is made whether the identifier matches a stored identifier (Step 207). Specifically, a determination is made whether the identifier that is transmitted by the user matches a previously stored identifier in the messaging infrastructure.

If an identifier match is found, the user receives menu instructions (step 209). The menu instructions may include a series of options that the user can select from in order to navigate through the messaging infrastructure. Specifically, menu instructions are a set of automated response messages, such as “record a message”—to provide the user with an option to record a message, “input a different identifier,” etc., that enable the user to interact effectively with the messaging infrastructure.

Next, a determination is made whether the user decides to record a message (Step 211). If the user decides not to record a message, then the user may terminate the session. Accordingly, a determination is made whether the user wants to terminate the session (Step 223). If the user wants to terminate the session, then the user may be provided with closing instructions and the session is terminated.

While FIG. 2 shows the possibility of recording a message and terminating the session, other options may also be available. For example, the user may input a different identifier, request to receive instructions about programs available, or perform any other option deemed appropriate according to the situation.

If the user decides to record a message, then the user may receive recording instructions (Step 212). Specifically, the user may receive instructions describing how to record the message and store the message in the messaging infrastructure. Accordingly, the user records the message (Step 213). Specifically, the user may verbalize the message into the user communication device, type the message using the user communication device, or perform any similar function. The message that the user records may include the location of the user, the status of the user (e.g., healthy, in good spirits, etc.), contact information for the user, information about others connected to the user, or any other such relevant information.

Once the user has recorded the message, then an optional determination is made whether to review the recorded message (Step 215). If the user chooses to review the recorded message, then the recorded message is reviewed (Step 217). Specifically, the recorded message may be transmitted to the user communication device and played for the user.

After reviewing the recorded message, a determination is made whether to re-record the message (Step 219). For example, if the user is not satisfied with the recorded message, then the user may delete the old message and record a new message. If the user decides to re-record the message, then the user may receive recording instructions for recording the message (Step 212) in accordance with one or more embodiments of the invention. The process may be repeated until the user is satisfied with the recorded message and selects not to review the most recently recorded message or chooses to not re-record after reviewing a recorded message.

Returning to Step 207, alternatively, if the identifier matches the one provided by the user, then the user receives matching messages from a messaging system within the messaging infrastructure (Step 221). Specifically, the current user may receive messages that are recorded by a previous user using the same identifier. Thus, the user is able to ascertain information about a previous user and contact the previous user directly. In one or more embodiments of the invention, because the identifier is distinct for the user or for a group of users, the messages that are transmitted to the current user are relevant to the user.

Once the user has received messages from a previous user(s), the user receives menu instructions as previously described (Step 209). At this stage, the user may want to record another message in response to the received message left by the previous user.

However, if the user does not choose to record a message, then the user may terminate the session (as discussed above). A final automated response message may be transmitted to the user to thank the user for using the system, reminding the user to check back again later to retrieve more messages. Alternatively, the final automated response message may correspond to a different set of instructions as deemed appropriate.

While FIG. 2 shows a flowchart of a method whereby the identifier is separate from the number or address used to initiate communication with the messaging system, in one or more embodiments of the invention, the number or address used to initiate communication with the messaging system may correspond to the identifier. For example, a group may be assigned an access number or address to the messaging system. Thus, the user (i.e., a member of the group) uses the access number to initiate communication with the messaging system. Once communication is initiated, the user may be requested to reenter the access number or address. The user is then directed to a menu dedicated to the user for accessing messages for the group. Further, in one or more embodiments of the invention, the access number may be publicly available, such as through the Internet. For example, a user may access a web page, enter the name or identifier of another user or group, and receive the access number. Then, using the access number, the user may initiate communication with the messaging system.

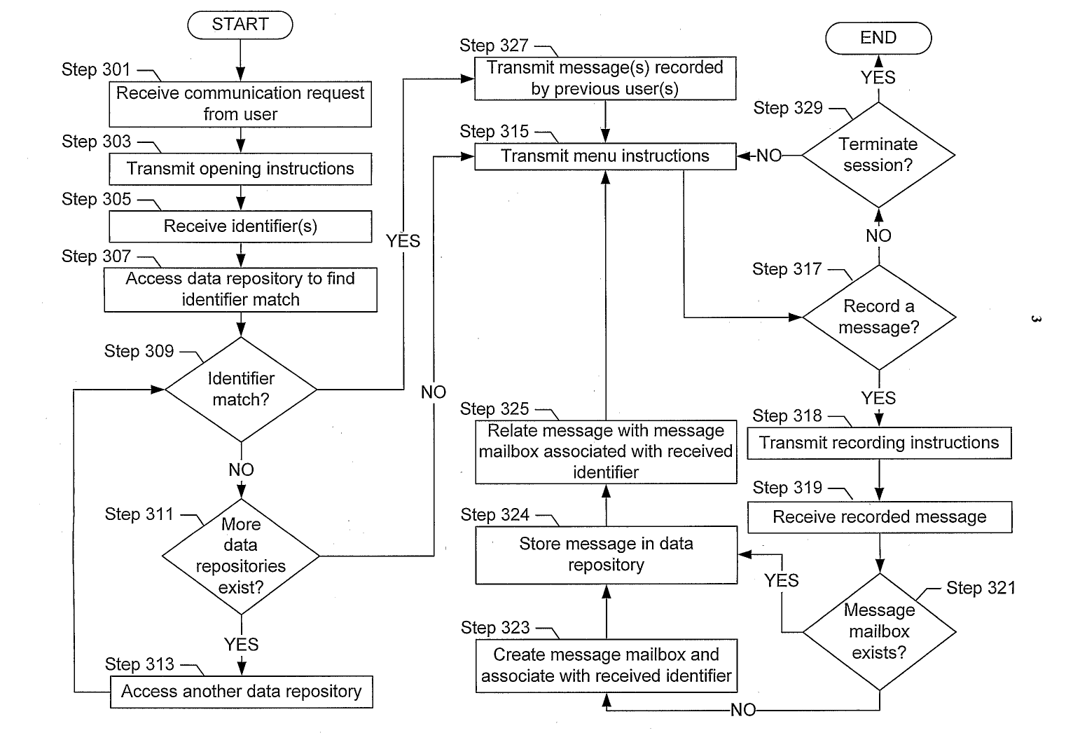

FIG. 3 shows a flowchart of a method for message storage and retrieval in accordance with one or more embodiments of the invention. Specifically, FIG. 3 shows multiple exemplary navigation paths through the messaging infrastructure.

Typically, communication with a user is initiated when a messaging system receives a communication request from the user (Step 301). The user may communicate with a messaging system directly (e.g., by using a number that is directly connected to the messaging system) or indirectly (e.g., by using a general number and being redirected to a messaging system that is handling the fewest users).

In response to this communication request, the communication manager corresponding to the messaging system transmits opening instructions (Step 303) to the user. Typically, the opening instructions include a series of instructions that enable the user to navigate effectively through functionality provided by the messaging system. The opening instructions may be played for a user, transmitted to the user communication device as text, etc.

As part of communicating with the messaging system, a user transmits an identifier to the messaging system. Accordingly, the identifier provided by the user is then received by the communication manager of the corresponding messaging system (Step 305). Thus, the communication manager accesses the corresponding data repository of the messaging system to find a matching identifier (Step 307). Specifically, the communication manager may query the data repository corresponding to the messaging system to determine whether a mailbox exists that is associated with the identifier.

Thus, a determination is made whether an identifier match exists (Step 309). If an identifier match is not found in the corresponding data repository, then other data repositories may exist that contain the identifier (or a reference to the identifier). Specifically, if a collection of messaging systems exist that do not share a single data repository, or if the data repositories are not synchronized, then a mailbox associated with the data repository may exist in a different messaging system in accordance with one or more embodiments of the invention. Accordingly, a determination is made whether additional data repositories exist (Step 311). Specifically, the communication manager of the messaging system with which the user communicates may have a list for accessing other communication managers and/or data repositories.

Thus, if another data repository belonging to another messaging system on the messaging infrastructure exists, then the other data repository is accessed (Step 313). In particular, the communication manager of the messaging system with which the user communicates establishes communication with the communication manager of the remote messaging system over a network connection in accordance with one or more embodiments of the invention. The communication manager of the messaging system with which the user communicates provides the other communication manager with the identifier provided by the user. Subsequently, the other communication manager accesses the other data repository to determine whether a matching identifier exists in the other data repository (Step 309). Alternatively, the communication manager with which the user communicates may access the other data repository directly and bypass the other communication manager.

In the event that a match is found, a copy of the message(s) from the message mailbox that is associated with the identifier and is located on the other data repository of the other messaging system is sent to communication manager corresponding to the messaging system with which the user communicates. The communication manager may store the message on the data repository corresponding to the messaging system with which the user communicates, dynamically create a new message mailbox, associate the new message mailbox with the identifier provided by the user, and relate the message with the message mailbox associated with the identifier. Alternatively, the user may be instructed to contact the other messaging system or transferred directly to the other messaging system if a match is found (not shown).

Accordingly, the message(s) recorded by one or more previous users is transmitted to the current user (Step 327). Specifically, the messages may be played for the user to listen or to watch, the messages may be converted to text to allow the user to read the messages, etc.

Further, even if an identifier is found in one data repository, other data repositories may also be accessed to determine whether message mailbox associated with the identifier exists. For example, even if the contacted messaging system is located in New York, the first remote messaging system that is accessed is located in San Francisco, and San Francisco has the messages associated with the identifier, then a messaging system in Houston may also be accessed to determine whether messages exist on that system that are not in San Francisco.

Alternatively, if an identifier match is not found in the data repository of the remote messaging system, data repositories of any remaining messaging systems may be accessed and checked for an identifier match. If a match is not found in the messaging infrastructure or once the user has received the message(s) recorded by previous users, then the menu of instructions is transmitted to the user (Step 315).

The menu instructions may include a series of options that the user can select from in order to navigate through the messaging system. Specifically, menu instructions are a series of automated response messages (e.g., “record a message”—receives a recorded message from user, “receive general instructions”, etc.) which enable the user to interact effectively with the messaging system.

Next, a determination is made whether to record a message (Step 317). Specifically, the user may submit a request indicating the desire to record a new message. Accordingly, if the user selects to record a message, the recording instructions are transmitted to the user contacted messaging system (Step 318). Transmitting the recording instructions may be performed in a manner similar to transmitting the menu instructions. Thus, the user records a message and the recorded message are received (Step 319).

Once the recorded message is received, a determination is made whether a message mailbox associated with the identifier exists in the data repository (Step 321). Specifically, the identifier may have been previously received by the messaging system and a dynamically created message mailbox may have been associated with the identifier.

If the message mailbox associated with the identifier exists in the data repository, then the message is stored in the data repository (Step 324). Further, the message is related with the message mailbox that is associated with the received identifier (Step 325). Specifically, the message may be placed in a virtual container corresponding to the message mailbox, a database relationship may be defined between the message and the message mailbox, the message may be connected to a data structure representing the message mailbox, or any other technique known in the art may be performed to create a relationship between the message and the message mailbox. Further, the message may be broadcast to one or more messaging systems in the messaging infrastructure.

Alternatively, if the message mailbox associated with the identifier related to the recorded message does not exist in the data repository (i.e., the identifier has not been received previously by the messaging system), then a message mailbox is created and associated with the identifier (Step 323). Thus, even though an identifier may not previously exist in the data repository, a message may be stored for another user in the hope that the other user contacts the messaging infrastructure. Thus, the message is stored in the data repository and related with the message mailbox associated with the identifier (Step 325).

Returning to Step 317, if the user does not want to record a message, then a determination is made whether to terminate the session (Step 329). If the user selects to terminate the session, then a final automated voice response may be transmitted to the user and communication with the user communication device may be terminated. The final automated voice response may correspond to a “thank you” message to the user for using the system, reminding the user to “check back again later” for leaving and retrieving more messages. Alternatively, final automated voice response may correspond to a different set of voice responses as may be deemed appropriate. Finally, if the session should not be terminated, then the menu instructions transmitted to the user may include an option to record more messages.

While FIG. 3 shows the messaging system accessing other messaging system to obtain an identifier match, in one or more embodiments of the invention, data repositories on a messaging infrastructure may be kept synchronized. Specifically, creation and storage of a new message on a particular messaging system with a messaging infrastructure may trigger an event which will send a copy of that message along with the related identifier to rest of the messaging systems on the messaging infrastructure. More specifically, the communication manager of the messaging system on which the new message has been created and stored may transmit the message with the identifier to other communication managers on the messaging infrastructure. Other communication managers on the messaging infrastructure may store the message in the corresponding data repositories, associate the received identifier to a dynamically created mailbox, and relate the message to the message mailbox associated with the identifier.

Additionally, in one or more embodiments of the invention, the messages stored in a particular messaging system may be deleted automatically after a preset time interval. For example, the messaging system may be configured such that if a message has been on the messaging system for a period of thirty days, then the message is automatically deleted from the messaging system. The aforementioned date is configurable allowing change when conditions warrant the change. Further, to prevent accidental loss of important information, the user is not provided functionality to delete a message in accordance with one or more embodiments of the invention.

Furthermore, in one or more embodiments of the invention, the user may transmit multiple identifiers to the messaging system in a single session. A session is generally a time frame for using the system from log-in to log-out. For example, rather than initially transmitting a single identifier to obtain the messages for the identifier, the user may transmit multiple known identifiers. Further, when recording the message, the user may submit a collection of identifiers that should be associated with the message through multiple message mailboxes. Thus, a single message may be related with multiple message mailboxes. Alternatively, or in addition to, the user may record multiple messages for separate identifiers. For example, the user may record one message for an identifier associated with family and another message for an identifier associated with coworkers.

The following is an example of user interaction with the messaging infrastructure in accordance with one or more embodiments of the invention. For the example, consider the scenario in which a mother and son are separated in the event of a natural disaster or at a retail shopping center. Mother hears over the radio or a pager that the messaging system is available and listens for the toll free telephone number for the messaging system, which is also over the radio or pager.

Mother dials the messaging system and enters her home telephone number “713-999-1234”. In one embodiment of the invention, the messaging system checks for a match and gives her the option of listening to messages already left for that phone number and also the option of leaving a message. After hearing or leaving messages on the mailbox associated with the home number identifier, she then enters the telephone number of her husband's office (i.e., 281-456-7890) as an identifier, the cell phone number of her son (i.e., 512-567-1236) as an identifier, and grandmother's telephone number (i.e., 770-234-8765) as an identifier. The mother now has four ways of identifying her message for her son or anyone else calling in to find out information on mother.

The son is in another state (or in a different area of the store) and hears over the radio (or pager) that the messaging system has been activated and also takes note of the toll free telephone number. Borrowing a policeman's satellite telephone, the son calls the messaging system. The son enters his mother's home phone number, gets a match, and listens to the message in her message mailbox that she is safe and is in the Astrodome shelter in Houston, Tex. (or on the produce aisle). The son then leaves a “safe” message for his mother on the messaging system that can be accessed by the mother the next time she calls into the messaging system.

Continuing with the aforementioned example, suppose a sister is safe in Kansas City, Mo. but is still worried about her mother and brother. Once the sister is informed about the messaging system, she dials the toll free telephone number, and listens to the messages left by both her mother and brother. Knowing that both are safe and where each is located, the sister then leaves her own message to let them know that she knows they are safe and sending aid as soon as the roads are cleared. Mostly, the sister now has peace of mind that both her mother and brother are safe and each knows how the other one is.

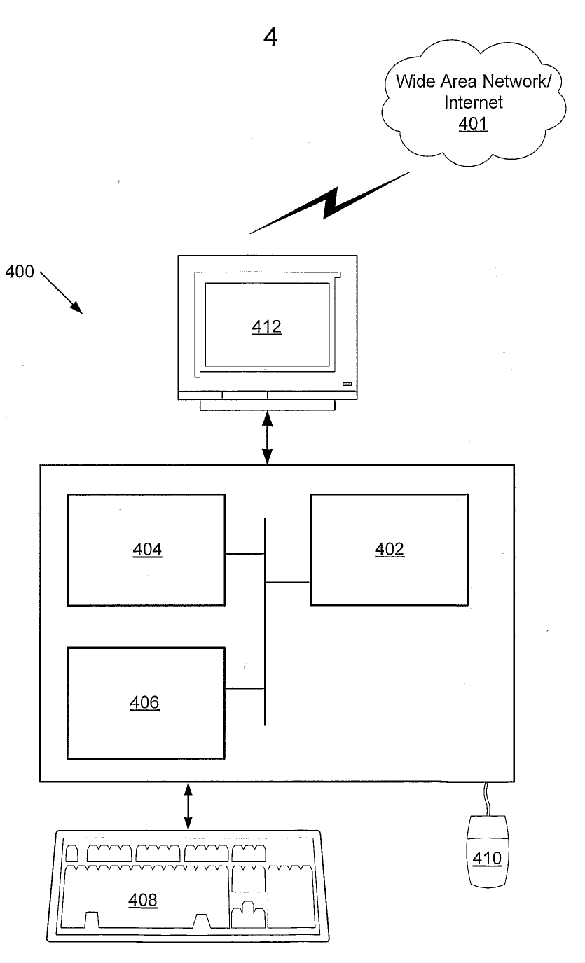

The invention may be implemented on virtually any type of computer regardless of the platform being used. For example, as shown in FIG. 4, a computer system (400) includes a processor (402), associated memory (404), a storage device (406), and numerous other elements and functionalities typical of today's computers (not shown). The computer (400) may also include input means, such as a keyboard (408) and a mouse (410), and output means, such as a monitor (412). The computer system (400) is connected to a local area network (LAN) or a wide area network (i.e., the Internet) (401) via a network interface connection. Those skilled in the art will appreciate that these input and output means may take other forms.

Further, those skilled in the art will appreciate that one or more elements of the aforementioned computer system (400) may be located at a remote location and connected to the other elements over a network. Further, the invention may be implemented on a distributed system having a plurality of nodes, where each portion of the invention (i.e., communication manager, data repository, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

In one or more embodiments of the invention, the messaging system is simple and easy to use. Specifically, the user does not have to remember any special number to use the messaging system and is guided through the process of leaving messages. Further, the identifying number for the message is typically a common number known by the user and other users interested in accessing the message left of the user. Additionally, by specifying multiple identifiers chances of making a match on at least one common number is increased dramatically. Further, the mailboxes and identifiers do not need to be pre-defined and can be provisioned and deployed instantaneously.

Further, in one or more embodiments of the invention, the messaging infrastructure is easily deployable. Specifically, by not requiring pre-existing accounts in the messaging system for users, the messaging infrastructure may be used by almost anyone, at any time, with no pre-planning required. More specifically, by dynamically creating and organizing messages in real time without any prior assignment of Personal Identification Numbers (PINs), extensions, codes, keys, or any other pre-assignment of identifying information, the messaging system does not require a user to have a disaster plan in the case of a natural disaster.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for message storage and retrieval comprising:
a first data repository; and
a first communication manager configured to:
obtain an identifier and a message from a first user;
create a first message mailbox associated with the identifier in the first data repository after receiving the message;
store the message in the first data repository;
relate the message with the first message mailbox associated with the identifier, and
retrieve the message from the first message mailbox associated with the identifier provided by a second user.

2. The system of claim 1, further comprising:
a user communication device configured to transmit the message and the identifier to the first communication manager.

3. The system of claim 2, wherein the user communication device is at least one selected from a group consisting of a mobile cellular telephone, a landline telephone, and a satellite phone.

4. The system of claim 2, wherein the user communication device is configured to access at least one selected from a group consisting of a wide area network and a telephone network.

5. The system of claim 1, wherein the message and the identifier are obtained from at least one selected from a group consisting of a telephone network and a wide area network.

6. The system of claim 1, wherein the first data repository is a relational database.

7. The system of claim 1, wherein the first data repository is configured to simultaneously relate the identifier with a plurality of messages.

8. The system of claim 1, wherein the first data repository is configured to simultaneously relate the message with a plurality of identifiers.

9. The system of claim 1, further comprising:
a second communication manager configured to:
receive the identifier from the second user;
transmit a request to the first communication manager based on the identifier provided by the second user;
receive the message from the first communication manager based on the request; and
provide the message to the second user.

10. The system of claim 9, further comprising:
a second data repository;
wherein the second communication manager is further configured to:
create a second message mailbox associated with the identifier in the second data repository after receiving the message;
store the message in the second data repository; and
associate the message with the second message mailbox associated with the identifier.

11. The system of claim 1, wherein the identifier is a numeric character set comprising a series of numbers known to the first user and the second user.

12. The system of claim 11, wherein the identifier is at least one selected from a group consisting of an address, a unique number of the second user, a unique number of the first user, and a telephone number.

13. The system of claim 1, wherein the identifier is obtained using a toll-free telephone number.

14. The system of claim 1, wherein the identifier is obtained using a web based interface.

15. The system of claim 1, wherein the message is automatically deleted after a preset time interval.

16. A method for message storage and retrieval comprising:
obtaining an identifier and a message from a first user;
creating a first message mailbox associated with the identifier in a messaging infrastructure after receiving the message;
storing the message in the messaging infrastructure;
relating the message with the first message mailbox associated with the identifier;
retrieving the message from the first message mailbox associated with the identifier provided by a second user.

17. The method of claim 16, wherein the messaging infrastructure comprises a first messaging system and a second messaging system, wherein the first messaging system and the second messaging system are geographically dispersed.

18. The method of claim 17, further comprising:
receiving the identifier from the second user by the second messaging system;
transmitting a request to the first messaging system based on the identifier provided by the second user;
receiving the message from the first messaging system based on the request; and
forwarding the message to the second user by the second messaging system.

19. The method of claim 16, further comprising:
creating a second message mailbox associated with the identifier in the second messaging system after receiving the message;
storing the message in the second messaging system; and
relating the message with the second message mailbox associated with the identifier, wherein the first message mailbox is created in the first messaging system.

20. The method of claim 16, further comprising:
receiving the identifier from the second user by the first messaging system; and
transmitting the message to the second user by the first messaging system,
wherein the first message mailbox is created in the first messaging system.

21. The method of claim 16, wherein the identifier is a numeric character set comprising a series of numbers known to the first user and the second user.

22. The method of claim 21, wherein the identifier is at least one selected from a group consisting of an address, a unique number of the second user, a unique number of the first user, and a telephone number.

23. The method of claim 16, wherein the identifier is obtained using a toll-free number.

24. The method of claim 16, wherein the identifier is obtained using a web based interface.

25. The method of claim 16, wherein the message is automatically deleted after a preset time interval.

26. The method of claim 16, wherein the identifier is simultaneously associated with a plurality of messages.

27. The method of claim 16, wherein the message is simultaneously associated with a plurality of multiple identifiers.

28. A computer readable medium comprising instructions embodied thereon for causing a computer system to:
obtain an identifier and a message from a first user;
create a first message mailbox associated with the identifier in a messaging infrastructure after receiving the message;
store the message in the messaging infrastructure;
relate the message with the first message mailbox associated with the identifier;
retrieve the message from the first message mailbox associated with the identifier provided by a second user.
